(19) United States
(12) Patent Application Publication
(10) Pub. No.: US 2024/0112088 A1
(43) Pub. Date: Apr. 4, 2024

(54) Vector-Quantized Image Modeling

(71) Applicant: Google LLC, Mountain View, CA (US)

(72) Inventors: Jiahui Yu, Jersey City, NJ (US); Xin Li, Santa Clara, CA (US); Han Zhang, Sunnyvale, CA (US); Vijay Vasudevan, Los Altos Hills, CA (US); Alexander Yeong-Shiuh Ku, Brooklyn, NY (US); Jason Michael Baldridge, Austin, TX (US); Yuanzhong Xu, Mountain View, CA (US); Jing Yu Koh, Austin, TX (US); Thang Minh Luong, Santa Clara, CA (US); Gunjan Baid, San Francisco, CA (US); Zirui Wang, San Francisco, CA (US); Yonghui Wu, Palo Alto, CA (US)

(21) Appl. No.: 18/520,083

(22) Filed: Nov. 27, 2023

Related U.S. Application Data
(63) Continuation of application No. PCT/US2022/045756, filed on Oct. 5, 2022.
(60) Provisional application No. 63/351,131, filed on Jun. 10, 2022.
(60) Provisional application No. 63/252,452, filed on Oct. 5, 2021.

(51) Int. Cl. G06N 20/00

(52) U.S. Cl. CPC G06N 20/00

(57) ABSTRACT

Systems and methods are provided for vector-quantized image modeling using vision transformers and improved codebook handling. In particular, the present disclosure provides a Vector-quantized Image Modeling (VIM) approach that involves pretraining a machine learning model (e.g., Transformer model) to predict rasterized image tokens autoregressively. The discrete image tokens can be encoded from a learned Vision-Transformer-based VQGAN (example implementations of which can be referred to as ViT-VQGAN). The present disclosure proposes multiple improvements over vanilla VQGAN from architecture to codebook learning, yielding better efficiency and reconstruction fidelity. The improved ViT-VQGAN further improves vector-quantized image modeling tasks, including unconditional image generation, conditioned image generation (e.g., class-conditioned image generation), and unsupervised representation learning.

### RELATED APPLICATIONS

This application claims priority to and the benefit of U.S. Provisional Patent Application No. 63/351,131, Filed Jun. 10, 2022 and U.S. Provisional Patent Application No. 63/252,452, Filed Oct. 5, 2021. Each of the aforementioned applications is hereby incorporated by reference in its entirety.

### FIELD

The present disclosure relates generally to image modeling such as image synthesis and/or image generation. More particularly, the present disclosure relates to vector-quantized image modeling using vision transformers and improved codebook handling.

### BACKGROUND

In computer vision, the majority of recent unsupervised or self-supervised learning techniques focus on applying different random augmentations to an image with the pretraining objective to distinguish image instances, where the quality of learned representation relies on manually-picked augmentations like random brightness, cropping, blurring and more.

Certain other approaches apply GPT-style generative pretraining on images to autoregressively predict pixels without incorporating knowledge of the 2D structure, where the pixel is a 9-bit value created by clustering (R, G, B) pixel values using k-means with k=512. However, the color encoding does not scale to typical image resolutions due to much longer sequence length (e.g., 224×224 resolution leads to 50,176 tokens per image) with much larger memory consumption and more training compute than those in language models. As a result, these works are only able to be applied on a relatively small maximal resolution (e.g., 64×64) for image recognition at scale, which severely limits the representation capabilities.

On the other hand, remarkable image generation results have been achieved by pre-quantizing images into discrete latent variables and modeling them autoregressively, including VQVAE (Oord et al., 2017), DALL-E (Ramesh et al., 2021) and VQGAN (Esser et al., 2021). In these approaches, a convolution neural network (CNN) is learned to auto-encode an image and a second stage CNN or Transformer is learned to model the density of input data. These have been proved effective for image generation, but few studies have evaluated the learned representation in discriminative tasks.

One sub-field of image generation is text-to-image generation, in which an image is synthesized based on a input text, where the synthesized image depicts content described by the input text. The ability to generate images through language is appealing because language is the most natural form of communication, and such generation capability can potentially unlock creative applications in many areas such as arts, design, and multimedia content creation. One line of research that has recently gained momentum in the text-to-image generation space are techniques that leverage diffusion-based text-to-image models with the ability to generate higher-fidelity images. These models eschew from the use of discrete image tokens and instead use diffusion models as the core modeling approach for image generation, achieving better zero-shot Fréchet Inception Distance (FID) scores on MS-COCO and aesthetically pleasing visual outputs. Despite these advances, being able to apply autoregressive modeling to the task of text-to-image generation remains practically appealing given a rich body of prior works on large language models and the universal interface of discrete tokens, which is readily applicable to many more modalities.

### SUMMARY

Aspects and advantages of embodiments of the present disclosure will be set forth in part in the following description, or can be learned from the description, or can be learned through practice of the embodiments.

One example aspect of the present disclosure is directed to computer-implemented method to perform vector quantization of imagery. The method includes obtaining, by a computing system comprising one or more computing devices, a plurality of input image patches of an image. The method includes processing, by the computing system, the plurality of input image patches with a machine-learned image encoder to generate a plurality of image tokens in a latent space, wherein the plurality of image tokens correspond to the plurality of input image patches, and wherein the machine-learned image encoder performs one or more self-attention operations to process the plurality of input image patches to generate the plurality of image tokens in the latent space. The method includes mapping, by the computing system, the plurality of image tokens to a plurality of quantized codes contained in a quantization codebook that contains a plurality of candidate codes. The method includes providing, by the computing system, the plurality of quantized codes as an encoded version of the image.

In some implementations, the machine-learned image encoder comprises a vision transformer model.

In some implementations, the machine-learned image encoder performs one of the one or more self-attention operations on the plurality of input image patches.

In some implementations, the method further includes processing, by the computing system, the plurality of quantized codes with a machine-learned image decoder to generate a plurality of synthesized image patches that form a synthesized image; evaluating, by the computing system, a loss function that provides a loss value based at least in part on the synthesized image; and modifying, by the computing system, one or more of: the machine-learned image encoder, the machine-learned image decoder, and the plurality of candidate codes based at least in part on the loss function.

In some implementations, the machine-learned image decoder comprises a vision transformer model.

In some implementations, the loss function includes: a logit-Laplace loss term; an L2 loss term; a perceptual loss term; and/or a generative adversarial network loss term.

In some implementations, mapping, by the computing system, the plurality of image tokens to the plurality of quantized codes contained in the quantization codebook that contains the plurality of candidate codes comprises: projecting, by the computing system, the plurality of image tokens to a lower-dimensional space; and after projecting the image tokens to the lower-dimensional space, mapping, by the computing system, the plurality of image tokens to the plurality of quantized codes contained in the quantization codebook.

In some implementations, mapping, by the computing system, the plurality of image tokens to the plurality of quantized codes contained in the quantization codebook that contains the plurality of candidate codes comprises: applying, by the computing system, an L2 normalization to one or both of the plurality of image tokens and the plurality of candidate codes; and after applying the L2 normalization, mapping, by the computing system, the plurality of image tokens to the plurality of quantized codes contained in the quantization codebook.

In some implementations, the method further includes autoregressively predicting, by the computing system using a machine-learned code prediction model, a plurality of predicted codes from the quantization codebook based at least in part on one or more of the plurality of quantized codes; and processing, by the computing system, the plurality of predicted codes with a machine-learned image decoder to generate a plurality of synthesized image patches that form a synthesized image.

In some implementations, the method further includes evaluating, by the computing system, a code prediction loss function that evaluates a negative log-likelihood based on the plurality of predicted codes; and modifying, by the computing system, one or more parameters of the machine-learned code prediction model based on the code prediction loss function.

In some implementations, autoregressively predicting, by the computing system using the machine-learned code prediction model, the plurality of predicted codes comprises conditioning, by the computing system, the machine-learned code prediction model with auxiliary conditioning data descriptive of one or more desired characteristics of the synthesized image.

In some implementations, the auxiliary conditioning data comprises a class label descriptive of a desired class of the synthesized image.

In some implementations, the auxiliary conditioning data comprises natural language text tokens.

In some implementations, the method further includes extracting, by the computing system, one or more intermediate features from the machine-learned code prediction model; and predicting, by the computing system, a class label for the image based at least in part on the intermediate features.

Another example aspect is directed to a computer-implemented method to perform vector quantization of imagery. The method includes obtaining, by a computing system comprising one or more computing devices, a plurality of quantized codes that form an encoded version of an image, wherein the plurality of quantized codes were selected by mapping a plurality of image tokens generated by a machine-learned image encoder model to the plurality of quantized codes contained in a quantization codebook that contains a plurality of candidate codes. The method includes processing, by the computing system, the plurality of quantized codes with a machine-learned image decoder to generate a plurality of decoded image patches that form a decoded version of the image. In some implementations, one or both of the machine-learned image encoder model and the machine-learned image decoder are configured to perform one or more self-attention operations.

Another example aspect is directed to a computer system comprising one or more processors and one or more non-transitory computer-readable media that collectively store instructions that when executed by the one or more processors cause the one or more processors to perform any of the methods described herein.

Another example aspect is directed to a one or more non-transitory computer-readable media that collectively store instructions that when executed by one or more processors cause the one or more processors to perform any of the methods described herein.

Another example aspect is directed to a computing system comprising one or more processors and one or more non-transitory computer-readable media that collectively store a machine-learned image processing model. The machine-learned image processing model comprises: an encoder portion configured to encode one or more input image patches into one or more image tokens in a latent space; a quantization portion configured to quantize the one or more image tokens into one or more quantized codes selected from a codebook; a code prediction portion configured to predict one or more predicted quantized codes from the codebook based at least in part on the one or more quantized codes; and a discriminative prediction portion configured to generate one or more discriminative predictions for the input image patches based at least in part on data extracted from the code prediction portion.

In some implementations, the machine-learned image processing model further comprises a decoder portion configured to generate reconstructed image patches based on the one or more quantized codes or to generate synthetic image patches based at least in part on the one or more predicted quantized codes.

In some implementations, the one or more discriminative predictions comprise image classification predictions.

Another example aspect is directed to a computer-implemented method to perform text-to-image generation. The method includes obtaining, by a computing system comprising one or more computing devices, a natural language input descriptive of desired image content. The method includes processing, by the computing system, the natural language input with a text encoder portion of a machine-learned code prediction model to generate a text embedding. The method includes processing, by the computing system, the text embedding with an autoregressive code selection portion of the machine-learned code prediction model to autoregressively predict a sequence of predicted codes from a quantization codebook that contains a plurality of candidate codes. The method includes processing, by the computing system, the sequence of quantized codes with a machine-learned image decoder to generate a plurality of synthesized image patches that form a synthesized image. The synthesized image depicts the desired image content.

In some implementations, one or more of the text encoder portion of the machine-learned code prediction model, the autoregressive code selection portion of the machine-learned code prediction model, and the machine-learned image decoder are configured to perform one or more self-attention operations.

In some implementations, one or more of the text encoder portion of the machine-learned code prediction model, the autoregressive code selection portion of the machine-learned code prediction model, and the machine-learned image decoder comprise transformer neural networks.

In some implementations, one or both of the machine-learned image decoder and the codebook were jointly learned with an image encoder model.

In some implementations, the text encoder portion of the machine-learned code prediction model was pre-trained on a pre-training task.

Another example aspect is directed to a computer-implemented method to train a code prediction model. The method includes obtaining, by a computing system comprising one or more computing devices, a training example comprising a training image and a natural language input descriptive of content of the training image. The method includes processing, by the computing system, a plurality of image patches from the training image with a machine-learned image encoder to generate a plurality of image tokens in a latent space, wherein the plurality of image tokens correspond to the plurality of image patches. The method includes mapping, by the computing system, the plurality of image tokens to a plurality of quantized codes contained in a quantization codebook that contains a plurality of candidate codes. The method includes processing, by the computing system, the natural language input with a text encoder portion of the code prediction model to generate a text embedding. The method includes processing, by the computing system, the text embedding with an autoregressive code selection portion of the code prediction model to autoregressively predict a sequence of predicted codes from the quantization codebook. The method includes evaluating, by the computing system, a code prediction loss function that compares the sequence of predicted codes to the plurality of quantized codes. The method includes modifying, by the computing system, one or more parameters of the code prediction model based at least in part on the code prediction loss function.

In some implementations, the machine-learned image encoder performs one or more self-attention operations to process the plurality of input image patches to generate the plurality of image tokens in the latent space.

In some implementations, the code prediction loss function evaluates a negative log-likelihood of the predicted codes relative to the quantized codes.

In some implementations, the machine-learned image encoder and the codebook has been previously trained with an image decoder in an autoencoder architecture.

In some implementations, modifying, by the computing system, one or more parameters of the code prediction model based at least in part on the code prediction loss function comprises modifying, by the computing system, one or more parameters of both the text encoder portion and the autoregressive code selection portion of the code prediction model based at least in part on the code prediction loss function.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a graphical diagram of example machine learning models for performing vector quantization of imagery according to example embodiments of the present disclosure.

FIG. 2 depicts a graphical diagram of example machine learning models for performing image generation according to example embodiments of the present disclosure.

FIG. 3 depicts a graphical diagram of example machine learning models for performing image generation according to example embodiments of the present disclosure.

FIG. 4 depicts a graphical diagram of example machine learning models for performing image generation according to example embodiments of the present disclosure.

FIG. 5 depicts a graphical overview of an approach to perform text-to-image generation according to example embodiments of the present disclosure.

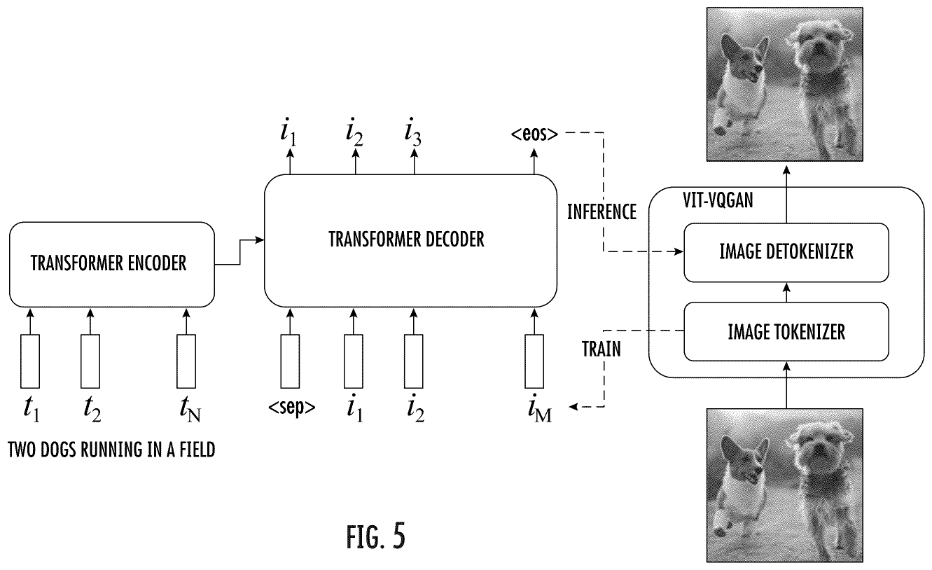

FIG. 6 depicts a graphical diagram of an example approach to scale model training according to example embodiments of the present disclosure.

FIG. 7 depicts a graphical diagram of an example model parallelism approach according to example embodiments of the present disclosure.

FIG. 8A depicts a block diagram of an example computing system according to example embodiments of the present disclosure.

FIG. 8B depicts a block diagram of an example computing device according to example embodiments of the present disclosure.

FIG. 8C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to vector-quantized image modeling using vision transformers and improved codebook handling. In particular, the present disclosure provides a Vector-quantized Image Modeling (VIM) approach that involves pretraining a machine learning model (e.g., Transformer model) to predict rasterized image tokens autoregressively. The discrete image tokens can be encoded from a learned Vision-Transformer-based VQGAN (example implementations of which can be referred to as ViT-VQGAN). The present disclosure proposes multiple improvements over vanilla VQGAN from architecture to codebook learning, yielding better efficiency and reconstruction fidelity. The improved ViT-VQGAN further improves vector-quantized image modeling tasks, including unconditional image generation, conditioned image generation (e.g., class-conditioned image generation), and unsupervised representation learning.

Example experiments demonstrate the technical effectiveness of the proposed techniques. In particular, when trained on ImageNet at 256×256 resolution, example implementations of the present disclosure achieve Inception Score (IS) of 175.1 and Frechet Inception Distance (FID) of 4.17, a dramatic improvement over the vanilla VQGAN, which obtains 70.6 and 17.04 for IS and FID, respectively. Based on ViT-VQGAN and unsupervised pretraining, example experiments further evaluate the pretrained Transformer by averaging intermediate features, similar to Image GPT (iGPT). This ImageNet-pretrained VIM-L significantly beats iGPT-L on linear-probe accuracy from 60.3% to 72.1% for a similar model size. ViM-L also outperforms iGPT-XL which is trained with extra web image data and larger model size.

Another example aspect of the present disclosure is directed to application of the proposed vector-quantized image models to a text-to-image generation task. Specifically, the present disclosure provides autoregressive models that can generate photorealistic images from text descriptions, with distinct advantages from diffusion-based approaches. Example implementations of these models can be referred to as “Babeldraw”. In some implementations, Babeldraw uses an improved image tokenizer, the Transformer-based ViT-VQGAN described herein, to encode an image as a sequence of discrete tokens. This naturally reduces the task at hand into the familiar problem of machine translation, from text to image tokens. Second, by scaling the encoder-decoder Transformer parameters from 350M and 750M to 3B and 20B, consistent quality improvements are observed. Compared with recent diffusion-based models, the 20B Babeldraw model achieves a comparable zero-shot MS-COCO Frechet Inception Distance (FID) score of 7.31, and an unprecedented FID score of 4.03 when finetuned on MS-COCO train split. With a post super-resolution upsampler learned on the frozen 256×256 image tokenizer, Babeldraw reliably generates high-resolution photorealistic images.

Thus, example implementations of the present disclosure relate to the Vector-quantized Image Modeling (VIM) method for both image generation and image understanding tasks. Specifically, some example implementations adhere to the following two-stage approach:
Stage 1: Vector Quantization. Given an image (e.g., of resolution 256×256), a Vision-Transformer-based VQGAN encodes it into a number of discretized latent codes (e.g., 32×32) contained within a codebook (e.g., the codebook size can be 8192). The present disclosure proposes multiple improvements from architecture to codebook learning on top of VQGAN (Esser et al., 2021). The resulted ViT-VQGAN has better efficiency and reconstruction fidelity in terms of pixel-wise reconstruction metrics, Inception Score (IS) and Frechet Inception Distance (FID). ViT-VQGAN can be trained end-to-end on image-only data with a combined objective functions of logit-Laplace loss, L2 loss, adversarial loss, and/or perceptual loss.
Stage 2: Vector-quantized Image Modeling. Some example implementations can include training a Transformer model to predict rasterized (e.g., 32×32=1024) image tokens autoregressively, where image tokens are encoded by the frozen Stage 1 ViT-VQGAN. For unconditional image synthesis or unsupervised learning, a decoder-only Transformer model can be trained to predict the next tokens. For conditioned image synthesis (e.g., class-conditioned image synthesis), conditioning data (e.g., a class-id token) can be prepended at the beginning of all image tokens.

To evaluate the quality of unsupervised learning, the intermediate Transformer features can be extracted (e.g., and averaged) and a linear head can be trained to predict the logit of the classes (a.k.a., linear-probe accuracy).

One key component for improving both image generation and image understanding with VIM is to have a better image quantizer in terms of computational efficiency and reconstruction quality. An efficient quantizer can speed up Stage 2 training where random augmentations are firstly applied on images, followed by encoder of image quantizer as the input tokens. Moreover, an image quantizer with better reconstruction quality can potentially reduce information loss compared with the original image in pixel space, which is critical for image understanding tasks.

Additional example aspects of the present disclosure are directed to autoregressive image generation models that can generate photorealistic images from text descriptions. The autoregressive models provided herein can benefit from a better image tokenizer and also the scaling of the model. More specifically, the present disclosure provides a transformer-based sequence-to-sequence model for image generation (example implementations of which can be referred to as “Babeldraw”). The image generation model can take tokenized text tokens as inputs to an encoder and predict discrete image tokens with a decoder in an autoregressive fashion. The image tokens can, in some examples, be produced by the transformer-based ViT-VQGAN image tokenizer described herein, a better model than VQGAN in terms of efficiency and image reconstruction fidelity.

In some implementations, all components of the image generation model—encoder, decoder and image tokenizer—can be based on standard transformer model. This makes it easy to scale the models. To test the limits of the aforementioned two-stage text-to-image framework, the parameter size of example Babeldraw models was scaled from 350M, to 750M, 3B, and 20B, and quality improvements were observed both in terms of text-image alignment and image photorealism. The 20B Babeldraw model achieves a strong zero-shot FID score of 7.31, comparable to state-of-the-art diffusion-based models. Remarkably, when finetuned on MS-COCO, an example Babeldraw model achieves an unprecedented low FID score of 4.07.

While most works fixate on the MS-COCO benchmark, example experiments show that strong zero-shot and finetuned results can also be achieved on the Localized Narratives dataset, which has descriptions that are 4 times longer than MS-COCO on average. These results clearly demonstrate the strong generalization capability of the proposed model to longer descriptions.

Thus, the present disclosure provides a number of contributions as relates to text-to-image generation. First, it is recognized that the image tokenizer is one of the key ingredients for two-stage text-to-image generation model, and has direct connection to the visual quality of generated images. Second, with the exact same image tokenizer and training data, simply scaling encoder-decoder is effective for text-to-image generation. Third, text encoder pretraining with BERT only mildly helps natural language understanding for text-to-image systems; the text encoder finetuned on text-to-image generation has worse results on language understanding tasks, suggesting a potential gap for general language understanding and visually-grounded language understanding.

The systems and methods of the present disclosure provide a number of technical effects and benefits. As one example, the proposed techniques are able to achieve comparable results to current state of the art models (e.g., iGPT) for certain tasks (e.g., image recognition with generative pre-training), but with a smaller model and less data. Enabling the use of a smaller model with less data (while obtaining comparable results), reduces the consumption of computational resources such as processor usage, memory usage, network bandwidth, etc. Thus, the proposed approaches save computing resources and are an improvement in the functioning of a computer.

As another example, example implementations of the present disclosure have superior efficiency and reconstruction fidelity in terms of pixel-wise reconstruction metrics, Inception Score (IS) and Frechet Inception Distance (FID) relative to existing models. Thus, the present disclosure represents an improvement in the ability to encode image data into an encoded representation. Encoding data has numerous benefits including savings of memory space and network bandwidth. The present disclosure enables a system to encode imagery to achieve such benefits, all while reducing the loss of data experienced when decoding the imagery to a decoded image.

As another example technical effect and benefit, the present disclosure provides improved image generation and image understanding with VIM by providing an improved image quantizer in terms of computational efficiency and reconstruction quality. An efficient quantizer can speed up Stage 2 training where random augmentations are firstly applied on images, followed by encoder of image quantizer as the input tokens. Increasing training speed can result in savings of computational resources such as processor usage, memory usage, and/or network bandwidth usage. Moreover, an image quantizer with better reconstruction quality can potentially reduce information loss compared with the original image in pixel space, which is critical for image understanding tasks. Thus, the performance of a computer on image understanding tasks can be improved.

With reference now to the Figures, example embodiments of the present disclosure will be discussed in further detail.

### Example Stage 1 Techniques

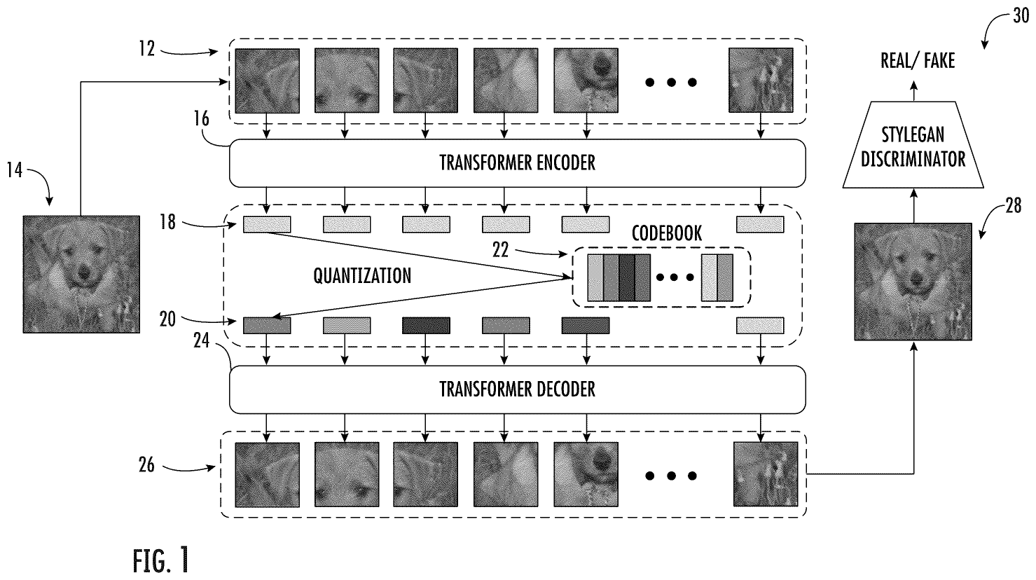

FIG. 1 depicts a graphical diagram of example machine learning models for performing vector quantization of imagery according to example embodiments of the present disclosure.

In particular, as shown in FIG. 1, a computing system can obtain a plurality of input image patches 12 of an image 14.

The computing system can process the plurality of input image patches 12 with a machine-learned image encoder 16 to generate a plurality of image tokens 18 in a latent space. The plurality of image tokens 18 can correspond to the plurality of input image patches 12. The machine-learned image encoder 16 can perform one or more self-attention operations to process the plurality of input image patches 12 to generate the plurality of image tokens 18 in the latent space.

The computing system can map the plurality of image tokens 18 to a plurality of quantized codes 20 contained in a quantization codebook 22 that contains a plurality of candidate codes. The computing system can provide the plurality of quantized codes 20 as an encoded version of the image.

Further, in some implementations, the computing system (i.e., the same or different component computing devices thereof) can process the plurality of quantized codes 20 with a machine-learned image decoder 24 to generate a plurality of synthesized image patches 26 that form a synthesized image 28.

The computing system can evaluate a loss function 30 that provides a loss value based at least in part on the synthesized image. The loss function can include a logit-Laplace loss term; an L2 loss term; a perceptual loss term; and/or a generative adversarial network loss term (e.g., the GAN evaluation is specifically illustrated at 30 while the others are not).

The computing system can modify one or more of: the machine-learned image encoder 16, the machine-learned image decoder 24, and the plurality of candidate codes 22 based at least in part on the loss function.

In some implementations, mapping the plurality of image tokens 18 to the plurality of quantized codes 20 can include projecting the plurality of image tokens 18 to a lower-dimensional space and, after projecting the image tokens 18 to the lower-dimensional space, mapping the plurality of image tokens to the plurality of quantized codes contained in the quantization codebook. The quantized codes 20 can then be re-projected back up to the higher-dimensional space prior to being processed by the decoder 24.

In some implementations, mapping the plurality of image tokens 18 to the plurality of quantized codes 20 can include applying an L2 normalization to one or both of the plurality of image tokens 18 and the plurality of candidate codes in the codebook 22 and, after applying the L2 normalization, mapping the plurality of image tokens 18 to the plurality of quantized codes 20 contained in the quantization codebook 22.

### Example Stage 2 Techniques

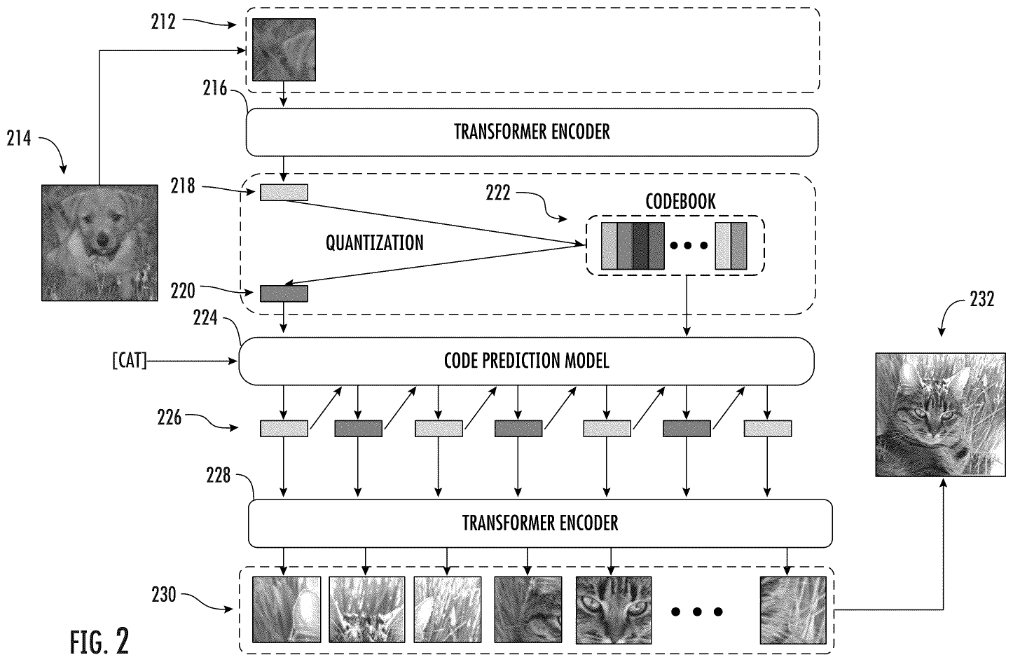

FIG. 2 depicts a graphical diagram of example machine learning models for performing vector quantization of imagery according to example embodiments of the present disclosure.

In particular, as shown in FIG. 2, a computing system can obtain one or more input image patches 212 of an image 214.

The computing system can process the one or more input image patches 212 with a machine-learned image encoder 216 to generate one or more image tokens 218 in a latent space. The one or more image tokens 218 can correspond to the one or more input image patches 212. The machine-learned image encoder 216 can perform one or more self-attention operations to process the one or more input image patches 212 to generate the one or more image tokens 218 in the latent space. For example, the machine-learned image encoder 216 can have been trained or learned according to the process shown in FIG. 1.

The computing system can map the one or more image tokens 218 to one or more quantized codes 220 contained in a quantization codebook 222 that contains a plurality of candidate codes. For example, the quantization codebook 222 can have been learned according to the process shown in FIG. 1.

Further, in some implementations, the computing system (i.e., the same or different component computing devices thereof) can process the one or more quantized codes 220 with a machine-learned code prediction model 224 to autoregressively predict a plurality of predicted codes 226 from the quantization codebook 222 based at least in part on the one or more quantized codes 220.

The computing system can process the plurality of predicted codes 226 with a machine-learned image decoder 228 to generate a plurality of synthesized image patches 230 that form a synthesized image 232.

In some implementations or instances, the computing system can further evaluate a code prediction loss function that evaluates a negative log-likelihood based on the plurality of predicted codes 226. The computing system can modify one or more parameters of the machine-learned code prediction model 224 based on the code prediction loss function. For example, the code prediction model 224 can be trained to learn the distribution of tokens over a corpus of imagery using, for example, the code prediction loss function.

In some implementations, during training and/or inference, the machine-learned code prediction model 224 can be conditioned with auxiliary conditioning data descriptive of one or more desired characteristics of the synthesized image. As one example, the auxiliary conditioning data can include a class label descriptive of a desired class of the synthesized image 232. For example, in FIG. 2, the model 224 is conditioned with the label of [Cat] so that the synthesized image 232 depicts a cat but the synthesized image 232 shares visual characteristics with the image 214. As another example, the auxiliary conditioning data can include natural language text tokens and/or any other conditioning data that provides a prior for the synthesis of the imagery.

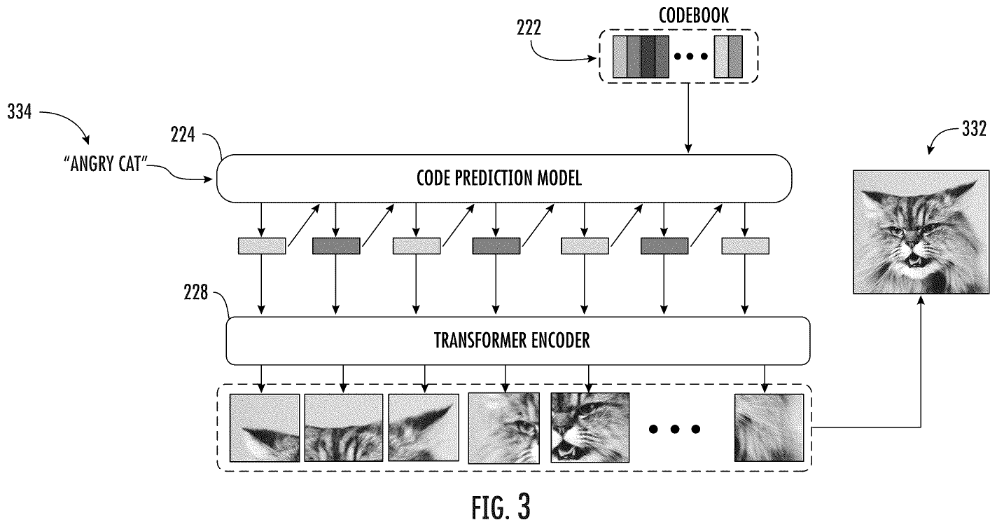

FIG. 2 shows an example approach in which the image generation process is conditioned both on patch(es) 212 from an input image 214 and also on a textual input (e.g., a class label). However, in some implementations, the image generation can be conditioned on text only. For example, FIG. 3 illustrates an example in which the generation of a synthetic image 332 is conditioned on a natural language input 334 of “angry cat.” For example, the natural language input 334 can be transformed into tokens and then provided as input to the code prediction model 224.

According to an aspect of the present disclosure, in some implementations that include text conditioning and/or perform a text-to-image generation task, the code prediction model 224 can include a text encoder that generates a text embedding from the textual input.

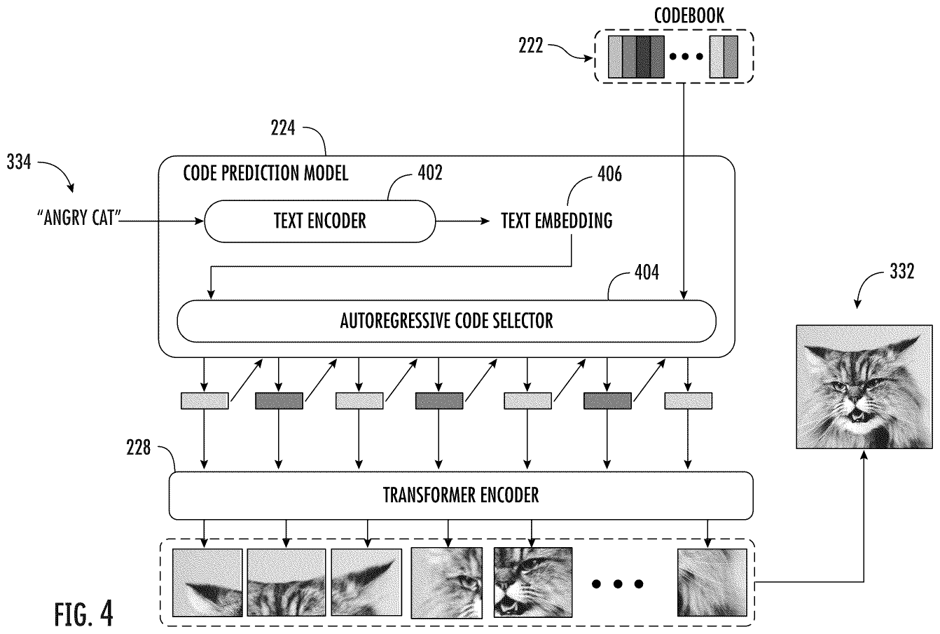

As an example, FIG. 4 shows an example image generation approach in which the code prediction model 224 includes a text encoder 402 and an autoregressive code selector 404. The text encoder 402 can receive the input text 334 and generate a text embedding 406. The text embedding 406 can be provided as an input to the autoregressive code selector 404. For example, the text embedding 406 can be provided as an initial prompting token to the autoregressive code selector 404.

In some implementations, one or both of the text encoder 402 and the autoregressive code selector 404 can be or include transformer models or other models that perform self-attention. In some implementations, the text encoder can be pre-trained (e.g., using masked language modeling pre-training approaches, contrastive learning approaches, and/or other pre-training approaches). In some implementations, the parameters of the text encoder 402 and the autoregressive code selector 404 can be trained jointly (e.g., using a code prediction loss function) to learn the distribution of tokens over a set of text and image training examples that each includes a pair of text and image.

### Example Vector-Quantized Images with ViT-VQGAN

The Vector-quantized Variational AutoEncoder (VQVAE) is a CNN-based auto-encoder whose latent space is a matrix of discrete learnable variables, trained end-to-end via straight-through estimation. VQGAN is a model which improves upon VQVAE by introducing an adversarial loss produced by a discriminator. Herein, further improvements to VQGAN are provided that boost efficiency and enhance reconstruction quality.

Example VQGAN with Vision Transformers

The core network architectures used by both VQVAE and VQGAN to encode and reconstruct images are CNNs. VQGAN introduces transformer-like elements in the form of non-local attention block, allowing it to capture distant interactions with fewer layers. Example implementations of the present disclosure this approach one step further by replacing the CNN encoder and decoder with Vision Transformer (ViT) . Given sufficient data (for which unlabeled image data is plentiful) we find that ViT-VQGAN is less constrained by the inductive priors imposed by convolutions. Furthermore, ViT-VQGAN yields better computational efficiency on accelerators, and produces higher quality reconstructions, as shown in Table 1 below.

TABLE 1
Example implementations of ViT-VQGAN achieve better speed-quality trade-
offs compared with CNN-VQGAN. This in turn further speeds up Stage 2 training.
Throughputs are benchmarked with the same 128 CloudTPUv4 devices.

| | Model Size | | | | | |
|---|---|---|---|---|---|---|
| | (encoder- | Throughput ↑ | [symbol] ₂ loss ↓ | Logit-Laplace | | |
| Architecture | decoder) | (imgs/sec) | (1e−2) | loss ↓ | FID ↓ | IS ↑ |
| ViT-VQGAN | Small-Small | 1520 | 3.34 | −2.44 | 1.99 | 184.4 |
| CNN-VQGAN | Channels × 1 | 946 | 3.81 | −2.36 | 2.26 | 178.7 |
| ViT-VQGAN | Base-Base | 960 | 3.09 | −2.54 | 1.55 | 190.2 |
| CNN-VQGAN | Channels × 2 | 400 | 3.44 | −2.46 | 1.91 | 183.4 |
| ViT-VQGAN | Small-Large | 384 | 2.88 | −2.58 | 1.28 | 192.3 |

An example encoder of ViT-VQGAN first maps 8×8 non-overlapping image patches into image tokens, followed by Transformer blocks, encoding a 256×256 resolution image into a 32×32=1024 token sequence. An example decoder performs the inverse operation, mapping each image token from latent variables back to 8×8 image patches and regrouping them into a 256×256 image. In some implementations, at the output of transformer blocks, we apply a two-layer feed-forward network with a tanh activation layer in the middle. In some implementations, no activation is applied at the output of ViT-VQGAN encoder or decoder (except the mean prediction of the logit-laplace loss). In some implementations, the sigmoid activation is applied for the mean prediction of the decoder due to the logit-laplace loss. This example approach yields high quality reconstructions without any noticeable grid artifacts.

### Example Codebook Learning

Vanilla VQVAEs usually suffer from low codebook usage due to the poor initialization of the codebook. Therefore, during training a significant portion of codes are rarely used, or dead. The reduction in effective codebook size results in worse reconstructions in stage 1 quantizer training and poor diversity in stage 2 for image synthesis. As a result, VQGAN relies on top-k and top-p (nucleus) sampling heuristics with a default codebook size of 1024 to obtain best results for image synthesis. Example implementations of the present disclosure include two improvements that can significantly encourage the codebook usage even with a larger codebook size of 8192. During image synthesis, example implementations perform simple sampling with temperature of 1.0 without top-k and top-p heuristics.

One example training objective of vector-quantization is defined as follows:

$${L}_{VW} = {‖ sg [ {z}_{e} ( x ) ] - e ‖}_{2}^{2} + β {‖ {z}_{e} ( x ) - sg [ e ] ‖}_{2}^{2} . \\ Here , sg ( x ) ≡ x , \frac{d}{dx} sg ( x ) ≡ 0 \qquad ( 1 )$$

is the stop-gradient operator, β is a commitment loss hyperparameter set to 0.25 in all our experiments, and e is the codebook vector. In some implementations, the quantized codebook index is determined by looking up the codebook vector closest to the input features zₑ(x) in terms of the Euclidean distance, yielding i=argminⱼ∥zₑ(x)−eⱼ∥₂².

Factorized codes. Some example implementations of the present disclosure include a linear projection from the output of the encoder to a low-dimensional latent variable space for code index lookup (reduced from a 768-d vector to a 32-d or 8-d vector per code). This has an immediate boost of codebook usage. The factorization can be viewed as decoupling code lookup and code embedding: some example implementations lookup the closest variable encoded from input on a lower-dimensional lookup space and then project the matched latent code to the high-dimensional embedding space. Example experiments show reducing dimension of lookup space from 256-d to 32-d consistently improves reconstruction quality.

[symbol] ₂-normalized codes. Some example implementations also apply [symbol] ₂ normalization on the encoded latent variables zₑ(x) and codebook latent variables e. In some implementations, the codebook variables are initialized from a normal distribution. By mapping all latent variables on a sphere, the Euclidean distance of [symbol] ₂-normalized latent variables ∥ [symbol] ₂(zₑ(x))− [symbol] ₂(eⱼ)∥₂² evolves to the cosine similarity of two vectors between zₑ(x) and e, further improving training stability and reconstruction quality shown in our experiments.

### Example ViT-VQGAN Training Losses

Some example implementations use a combination of logit-laplace loss, [symbol] ₂ loss, perceptual loss based on VGG network and GAN loss with architecture of StyleGAN discriminator. Loss balancing weights can be configured with a hyper-parameter sweep to optimize image reconstruction quality, codebook usage, FID and Inception Score. After the sweep, some example implementations apply the same set of hyper-parameters of training losses to all datasets including CelebA-HQ, FFHQ, and ImageNet. Logit-Laplace loss can be viewed as normalized [symbol] ₁ loss which assumes the noise at the pixel level is laplace-distributed while [symbol] ₂ loss assumes the noise is of a Gaussian distribution. We find logit-laplace loss contributes to codebook usage while [symbol] ₂ loss and perceptual loss significantly contribute to FID. The final loss combination we used by default is L=L_{VQ}+0.1 L_{Adv}+0.1 L_{Perceptual}+0.1 L_{Logit-laplace}+1.0 L₂.

One caveat on the VGG-based perceptual loss is that the VGG network is pretrained with supervised classification loss, so the supervision might leak into Stage 2 for linear-probe accuracy measurement. Thus, for all of our reported unsupervised learning results, some example implementations exclude the perceptual loss during ViT-VQGAN training. For all unconditional and class-conditioned image synthesis, some example implementations use ViT-VQGAN quantizers trained with perceptual loss, as it leads to higher-fidelity reconstructions.

### Example Vector-Quantized Image Modeling

With a learned ViT-VQGAN, images can be encoded into discrete latent code ids flattened in the raster order, similar to Image GPT. A decoder-only Transformer model can be used to model the density of image data P(x) autoregressively as

$$P ( x ) = {\prod }_{i = 1}^{n} P ( {x}_{i} \vert {x}_{1} , {x}_{2} , … , {x}_{i - 1} ; θ ) , \qquad ( 2 )$$

where θ is learnable weights. The training objective is to minimize the negative log-likelihood of the data L= [symbol] _{x∈X}[−log P(x)].

Table 2 summarizes example architecture configurations for the Transformers. Some example implementations first embed discrete image token ids into a learnable embedding space at each position, with an additive learnable 2D positional embedding. Both embedding dimensions are the same as model dimension. Some example implementations apply a stack of Transformer blocks to the inputs with causal attention over the entire sequence. A dropout ratio of 0.1 can be used in all residual, activation and attention outputs. At the final layer of all Transformer blocks, some example implementations apply an additional layer normalization.

TABLE 2
Example Transformer architectures of Stage 1 ViT-VQGAN and Stage 2 VIM.

| | | | | | Model | Hidden | | |
|---|---|---|---|---|---|---|---|---|
| Model | Size | #Params | #Blocks | #Heads | Dim | Dim | Dropout | #Tokens |
| ViT-VQGAN | Small | 32M | 8 | 8 | 512 | 2048 | 0.0 | 1024 |
| ViT-VQGAN | Base | 91M | 12 | 12 | 768 | 3072 | 0.0 | 1024 |
| ViT-VQGAN | Large | 599M | 32 | 16 | 1280 | 5120 | 0.0 | 1024 |
| VIM | Base | 650M | 24 | 16 | 1536 | 6144 | 0.1 | 1024 |
| VIM | Large | 1697M | 36 | 32 | 2048 | 8192 | 0.1 | 1024 |

### Example Image Synthesis

With a pretrained generative Transformer model, unconditional image generation can be achieved by simply sampling token-by-token from the output softmax distribution. All samples used for both qualitative and quantitative results can be obtained without temperature reduction. The sampled tokens can then be fed into the decoder of ViT-VQGAN to decode output images. An example default Stage 1 ViT-VQGAN encodes input images of resolution 256×256 into 32×32 latent codes with a codebook size 8192, while Stage 2 Transformer takes the flattened image tokens with total a length of 1024.

Class-conditioned ImageNet generation is also a widely used benchmark for measuring capabiltiy of models for image synthesis. Some example implementations extend the unconditional generation to class-conditioned generation by prepending a class-id token before the image tokens. Separate embedding layers can be learned from scratch for class-id token and image tokens, with the embedding dimension the same as the Transformer model dimension. During sampling, a class-id token can be provided at the first position to decode the remaining image tokens autoregressively.

### Example Unsupervised Learning

For the image understanding task, some example implementations feed all image tokens of the input into a pretrained Transformer, and get a sequence of 1024 token features. Some example implementations take a layer output at a specific block l over total blocks L, average over the sequence of token features (frozen) and insert a softmax layer (learnable) projecting averaged feature to class logits. Some example implementations only take one specific Transformer block output instead of concatenating different block outputs as in iGPT. Often, the most discriminating feature for the linear-probe is typically near the middle of all Transformer blocks.

### Example Babeldraw Models

Some example implementations of Babeldraw is a two-stage model composed of an image tokenizer and an autoregressive model over both language and image tokens.

### Example Image Tokenizer

Autoregressive text-to-image models rely on some forms of linearization of 2D images into 1D sequence of patch representations. In the limit, these are just pixels, but this requires modeling very long sequences for even relatively small images (e.g., a 256×256 image leads to 65536 rasterized pixels). Worse, it is based on a very low-level representation of the inputs rather than a richer one informed by the position of a pixel in the context of the image. Many works solved aforementioned problem by using a discrete variational auto-encoder to learn quantized representations of image patches over a collection of raw images. Instead of learning representations that can take any value in the latent space, a visual codebook is learned that snaps a patch embedding to its nearest codebook entry—which is a learned and index-able location in the overall latent space. These entries can be thought of as visual word types, and the appearance of any of these words in a patch in a given image is thus an image token.

To be most useful for the second stage model, the image tokenizer should learn (a) an effective visual codebook that supports balanced usage of its entries across a broad range of images and (b) support reconstruction of a sequence of visual tokens as a high-quality output image. Some example implementations use ViT-VQGAN, examples described herein, which addresses both requirements by using techniques that improve codebook learning: namely normalization and factorized codes which contribute to training stability, reconstruction quality and codebook usage.

For Babeldraw's image tokenizer, some example implementations train ViT-VQGAN as described above, but use the images in a larger image-text training data (e.g., instead of ImageNet, CelebA-HQ or FFHQ). Some example implementations first train a ViT-VQGAN-Small configuration (8 blocks, 8 heads, model dimension 512, and hidden dimension 2048), and learn 8192 image token classes for the codebook. Note that the 2nd stage encoder-decoder training only relies on the encoder and the codebook of a learned quantizer. To further improve visual acuity of the reconstructed images, some example implementations freeze the encoder and codebook after training, and fine-tune with a larger-size decoder (32 blocks, 16 heads, model dimension 1280, and hidden dimension 5120). Both the input and output of the image tokenizer can be of resolution 256×256.

Some example implementations demonstrate pixelation patterns (saturated pixel values) in the outputs of ViT-VQGAN when zooming in on some of the images. To resolve this issue, some example implementations remove the final sigmoid layer and expose the raw values as RGB pixel values (in range [0, 1]). Conveniently, this fix could be hot-swapped into an already trained model by fine-tuning the decoder.

In addition, while images of resolution 256×256 capture most of the contents, structures and textures, it is more visually pleasing with higher-resolution images like 512×512 or 1024×1024. To this end, some example implementations leverage a simple super-resolution module on top of the image tokenizer. Stacked convolutional layers with residual connections can be used as the super-resolution network module. It can be learned with the same losses of ViT-VQGAN (perceptual loss, StyleGAN loss and L2 loss) to map from reconstructed images to higher-resolution reconstructed images. Note that diffusion models could also be used here as iterative refinement super-resolution modules either with or without conditioning on text inputs.

Example Text-to-Image with Encoder-Decoder

In some example implementations, a standard encoder-decoder transformer model is trained at the second stage, by treating text-to-image as a sequence-to-sequence modeling problem. The model can take text as input and is trained using next-token prediction of image latent codes generated from the first stage image tokenizer. At inference time, the model can sample image tokens autoregressively, which are later decoded into pixels using the decoder of a previously learned image tokenizer.

Text prompts can be truncated to a maximum length of 128, and images of resolution 256×256 can be encoded into tokens of length 1024 (32×32). Some example implementations train with cross-entropy loss and use an int8-quantized Adafactor optimizer with constant-decaying second-moment factor (beta1=0.9, beta2=0.96). Data types can be cast to bfloat16 or attention projection and feed-forward transformers layers, while all layer norms and model output can be kept as float32. All models can use cony-shaped masked sparse attention, and some example implementations train four size variants ranging from 350 million to 20 billion parameters.

Most of the existing two-stage text-to-image generation models are decoder-only models. In early explorations at the scale of 350-million to 750-million parameters, it was found that encoder-decoder variants of Babeldraw outperformed decoder-only ones both in terms of training loss and text-to-image generation quality.

### Example Text Encoder Pretraining

The encoder-decoder architecture decouples text encoding from image-token generation. Thus, some example implementations also include a straightforward way to warm-start the model with a pretrained text encoder. Intuitively, a good text encoder for visual synthesis should be capable of generic language understanding in addition to visually-grounded prompts. Some example implementations pretrain text encoder on two datasets: the Colossal Clean Crawled Corpus (C4) with BERT pretraining objective, and the image-text dataset with contrastive learning objective. After pretraining, some example implementations continue training both encoder and decoder for text-to-image generation with softmax cross-entropy loss on a vocabulary of 8192 discrete image tokens.

### Example Classifier-Free Guidance and Reranking

Classifier-free guidance is usually used in the context of improving the sample quality of diffusion models without a pretrained classifiers. In this setup, a generative model G is trained to be able to perform unconditional generation G(z) (where z represents random noise) and conditional generation G(z, c) (where c represents some condition, such as language descriptions in our case). It is simply implemented as randomly dropping out conditional vector (masking out or switching to a learned embedding) with certain probability. Then, during the inference process, sampling of an output I is done by using a linear combination of the unconditional and conditional predictions:

I=G(z)+λ(G(z, c)−G(z)), (3)

where λ is a hyperparameter representing the weight of classifier-free guidance. Intuitively it decreases the unconditional likelihood of the sample while increasing the conditional likelihood, which can be viewed as improving the alignment of the generated sample with respect to the condition.

Classifier-free guidance has been similarly applied in the context of autoregressive models for text-to-image generation to great effect. One example approach finetunes the model while randomly replacing the text prompts with padded tokens. During inference, a linear combination of logits sampled from an unconditional model (conditioned on padding tokens) and a model conditioned on the original text prompt is taken.

Some example implementations also apply classifier-free guidance in Babeldraw, and find it has a positive impact on output quality especially on challenging text prompts. Some example implementations finetune the model for 100,000 steps, randomly replacing the text prompt with padding tokens. During sampling, some example implementations sample from logits from a linear combination of unconditional and conditional logits.

Some example implementations sample 16 images per text prompt. For each output, some example implementations rerank them based on the alignment score of image and text embedding of a Contrastive Captioners model (CoCa). A CoCa base-size model can be trained on the same dataset. It is noteworthy that reranking over a small set of images is computationally cheap in the text-to-image generation sampling.

### Example Scaling Approaches

Some example implementations use GSPMD and Lingvo framework to scale models on CloudTPUv4 hardware for both training and inference. GSPMD is an XLA compiler-based model partitioning system, which allows to treat a cluster of TPUs as a single virtual device, and use sharding annotations on a few tensors to instruct the compiler to automatically distribute the data and compute on thousands of devices.

Training. For both 350M and 750M model, some example implementations simply train the models with data parallelism. For the 3B model, some example implementations use 4-way in-layer model parallelism, and 128-way data parallelism. Partitioning a single dimension in each tensor is sufficient to scale a 3B model. The model weights can be partitioned on the feed-forward hidden dimension and the number of attention heads dimension; the internal activation tensors of the feed-forward and attention layers can also be partitioned on the hidden and heads dimensions, but a difference from Megatron-LM is that some example implementations also fully partition the output activations of feed-forward and attention layers on a different dimension (they do not have the hidden/heads dimensions). This strategy will result in ReduceScatter and AllGather communication patterns instead of AllReduce, which significantly reduce peak activation memory.

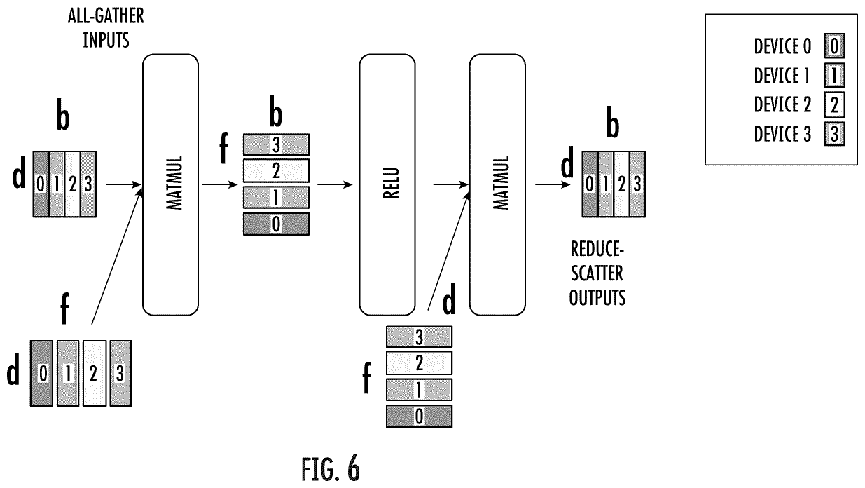

As one example, FIG. 6 depicts a graphical diagram of an example approach to scale model training according to example embodiments of the present disclosure. In particular, FIG. 6 is an illustration of 4-way in-layer model parallelism with fully partitioned activations to scale an example 3B model training. FIG. 6 shows a simplified Transformer feed-forward layer (with the sequence dimension omitted), and each shading represents data on one device. Some example implementations additionally use 128-way data parallelism.

One example 20B model has 16 encoder layers, and 64 decoder layers. The size of the weight in each layer is moderate (as opposed to being very wide), which makes pipeline parallelism a good option for scaling. A generic pipelining wrapper layer is implemented allowing example implementations to specify a single-stage program, which will later be automatically transformed into a multi-stage pipelining program; the wrapper layers uses vectorization and shifting buffers to reduce pipelining into a tensor partitioning problem thus all lower-level infrastructure can be reused for pipelining. There are two additional benefits from adoption of GSPMD pipelining: 1) it allows example implementations to conveniently configure pipelines within subcomponents of the model, which simplifies the overall complexity for encoder-decoder models, and 2) since pipelining is implemented as tensor partitioning on vectorized programs, example implementations can reuse the same set of devices for other types of parallelism outside the transformer layers.

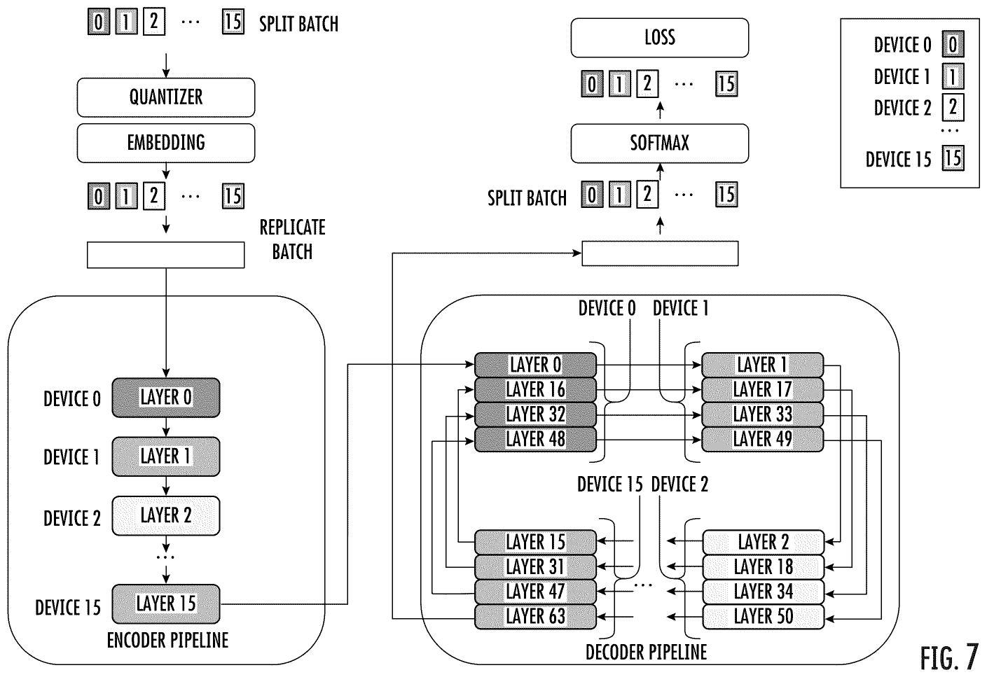

As one example, FIG. 7 depicts a graphical diagram of an example model parallelism approach according to example embodiments of the present disclosure. In particular, FIG. 7 depicts an illustration of example 16-stage GSPMD pipelines to scale an example 20B model training. FIG. 7 shows how the 16 devices are used for data parallelism in quantizer, embedding, and softmax layers, but repurposed for pipelining in the encoder and decoder layers. Each shading represents data or layer assigned to one device. The decoder users 4-round circular schedule to further reduce the pipeline bubble ratio. On top of this, example implementations additionally use 64-way data parallelism for all layers.

Some example implementations configure the model to have separate encoder and decoder pipelines, each of which has 16 stages. Some example implementations also use 64-way data parallelism in addition to pipelining to speed up training. However it makes per-core batch size small exposing an additional challenge of excessive pipeline bubbles. To reduce the ratio of pipeline bubbles, some example implementations adapt the circular schedule in the decoder pipeline, where the 4 layers in each stage are executed in a round-robin order. Outside the encoder and decoder, some example implementations use the same set of devices to do data parallelism instead of pipelining for the embedding, softmax, and image tokenizer layers.

During training, Adafactor optimizer can be used to save memory with beta1=0.9, beta2=0.96 and decoupled weight decay value of 4.5e-2. The first moments of optimizer slot variables are additionally quantized from float32 to int8. Some example implementations use default dropout ratio 0.1 for all models in both encoder and decoder. A deterministic version of dropout layer can be used in the 20B model to enable model pipelining. Some example implementations use a default learning rate of 4.5e-5 and exponential learning rate schedule with 5,000 warmup steps. The exponential decaying starts at training steps 85,000 with a total 450,000 steps and a final ratio of 0.025. Some example implementations do not use exponential moving average of the model weights to save device memory. For text encoding, some example implementations build a sentence-piece model of vocabulary size 16,000 on a subset of training data. Cony-shaped sparse attention can be used in the decoder transformers. Some example implementations additionally clip gradient norm to value of 4.0 to stabilize the training especially at the beginning. At the output of both encoder and decoder, some example implementations apply an additional layer normalization layer.

Inference. One primary goal for inference optimization is to speed up small-batch image generation. Some example implementations choose in-layer model parallelism for both the 3B and 20B models. As opposed to training, some example implementations do not fully partition the output activations for feedforward and attention layers for inference; this is because 1) each step of the auto-regressive decoding produces much smaller tensors and (at the time of writing) AllReduce performs better on small data, 2) activation memory is not a concern during inference which does not have a backward pass.

### Example Devices and Systems

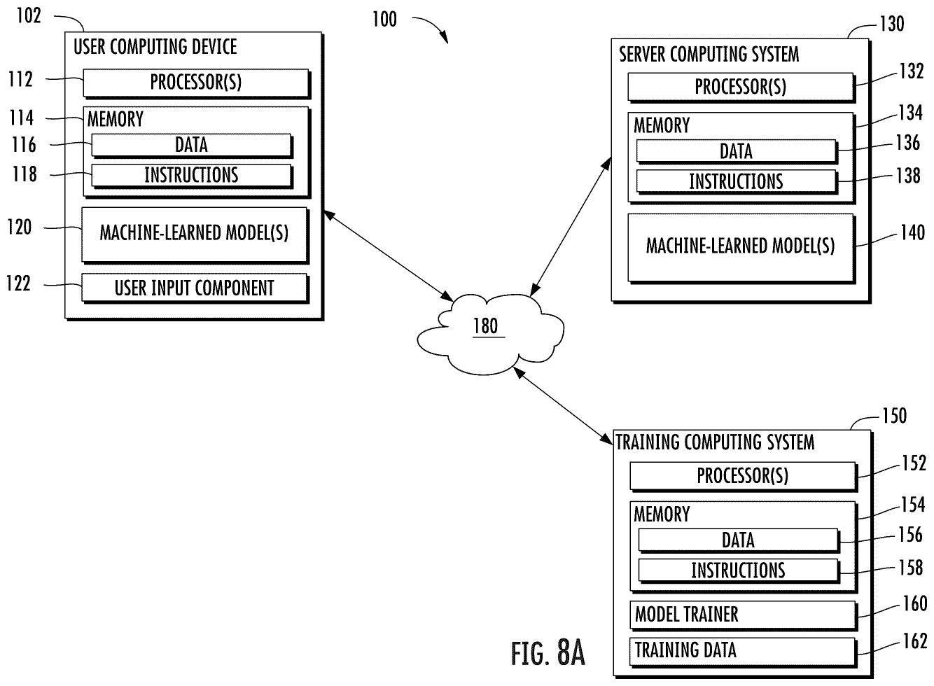

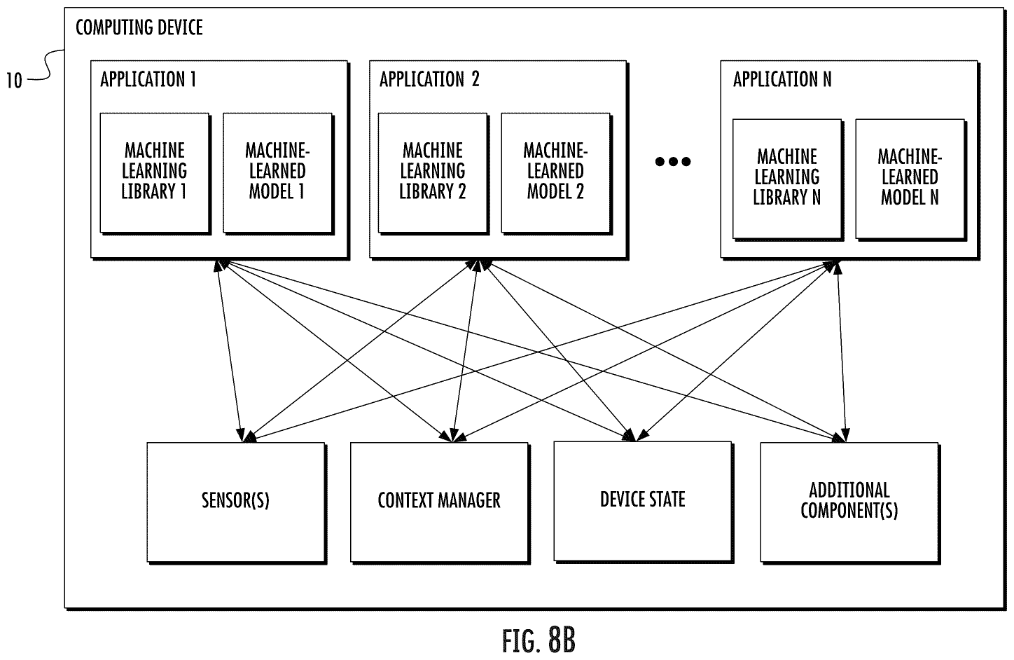

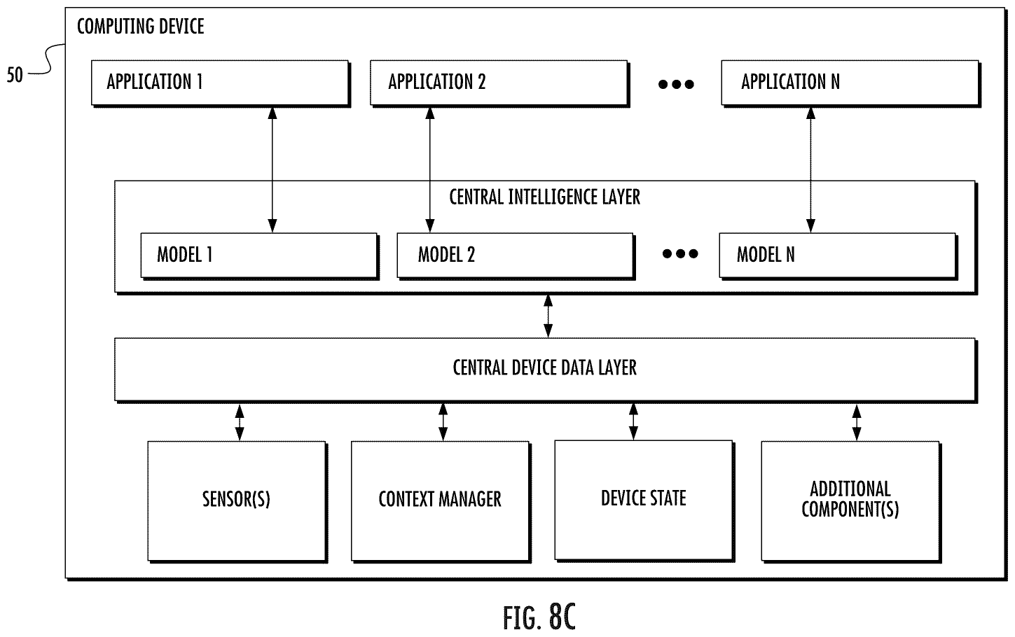

FIG. 8A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1 and 2.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel image quantization across multiple instances of images).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., an image quantization, understanding, and/or generation service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1 and 2.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, unsupervised and/or supervised training images.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

FIG. 8A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 8B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 8B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 8C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 8C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 8C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1-30. (canceled)

31. A computer-implemented method to train a machine learning model to generate imagery, the method comprising:
obtaining, by a computing system comprising one or more computing devices, an image;
processing, by the computing system, the image with a machine-learned image encoder to generate a plurality of tokens in a latent space;
obtaining, by the computing system, auxiliary conditioning data descriptive of one or more desired characteristics of a synthesized image;
processing, by the computing system, the plurality of tokens with a machine-learned image decoder to generate the synthesized image,
wherein the machine-learned image decoder applies one or more attention operations to the plurality of tokens, and
wherein processing, by the computing system, the plurality of tokens with a machine-learned image decoder to generate the synthesized image comprises conditioning, by the computing system, the machine-learned image decoder with the auxiliary conditioning data;
evaluating, by the computing system, a loss function that provides a loss value based at least in part on the synthesized image; and
modifying, by the computing system, one or more of: the machine-learned image encoder and the machine-learned image decoder based at least in part on the loss function.

32. The computer-implemented method of claim 31, wherein the loss function comprises:
an L2 loss term; or
a perceptual loss term.

33. The computer-implemented method of claim 31, wherein the auxiliary conditioning data comprises a class label descriptive of a desired class of the synthesized image.

34. The computer-implemented method of claim 31, wherein the auxiliary conditioning data comprises natural language text tokens.

35. The computer-implemented method of claim 34, wherein conditioning, by the computing system, the machine-learned image decoder with the natural language text tokens comprises:
processing, by the computing system, the natural language text tokens with a text encoder to generate a text embedding; and
providing, by the computing system, the text embedding as an input to the machine-learned image decoder.

36. The computer-implemented method of claim 35, wherein the text encoder comprises a transformer model.

37. A computing system configured to perform image generation, the computing system configured to perform operations, the operations comprising:
obtaining, by the computing system, a plurality of tokens in a latent space that form an encoded version of an image, wherein the plurality of tokens were generated by a machine-learned image encoder model; and
obtaining, by the computing system, auxiliary conditioning data descriptive of one or more desired characteristics of a decoded version of the image;
processing, by the computing system, the plurality of tokens in the latent space with a machine-learned image decoder to generate the decoded version of the image;
wherein the machine-learned image decoder is configured to perform one or more attention operations; and
wherein processing, by the computing system, the plurality of tokens with the machine-learned image decoder to generate the decoded version of the image comprises conditioning, by the computing system, the machine-learned image decoder with the auxiliary conditioning data.

38. The computing system of claim 37, wherein the auxiliary conditioning data comprises a class label descriptive of a desired class of the synthesized image.

39. The computing system of claim 37, wherein the auxiliary conditioning data comprises natural language text tokens.

40. The computing system of claim 39, wherein conditioning, by the computing system, the machine-learned image decoder with the natural language text tokens comprises:
processing, by the computing system, the natural language text tokens with a text encoder to generate a text embedding; and
providing, by the computing system, the text embedding as an input to the machine-learned image decoder.

41. The computing system of claim 40, wherein the text encoder comprises a transformer model.

42. One or more non-transitory computer-readable media that collectively store instructions for performing text-to-image generation, wherein, when executed by a computing system comprising one or more computing devices, the instructions cause the computing system to perform operations, the operations comprising:
obtaining, by the computing system, a natural language input descriptive of desired image content;
processing, by the computing system, the natural language input with a text encoder to generate a text embedding, wherein the text encoder comprises a transformer model; and
processing, by the computing system, the text embedding with a machine-learned image decoder to generate a synthesized image, wherein the machine-learned image decoder is configured to perform one or more attention operations;
wherein the synthesized image depicts the desired image content.

43. The one or more non-transitory computer-readable media of claim 38, wherein the text encoder was pre-trained on a pre-training task.
